(19) United States
(12) Patent Application Publication
(10) Pub. No.: US 2026/0017634 A1
(43) Pub. Date: Jan. 15, 2026

(54) ARTIFICIAL INTELLIGENCE (AI)-BASED SELF-CHECKOUT SCANNING VERIFICATION SYSTEM

(71) Applicant: TOSHIBA GLOBAL COMMERCE SOLUTIONS, INC., Durham, NC (US)

(72) Inventor: Patricia S. THOMAS, Cary, NC (US)

(21) Appl. No.: 18/768,924

(22) Filed: Jul. 10, 2024

(51) Int. Cl. G06Q 20/20

(52) U.S. Cl. CPC G06Q 20/208

(57) ABSTRACT

Methods and apparatus for performing artificial intelligence (AI)-based scanning verification for a self-checkout transaction using a self-checkout system are described. In an example method, a first image of multiple items within a shopping cart is displayed on a display system of the self-checkout system. A scanning of a first item of the multiple items with a handheld scanner associated with the self-checkout system is detected. A second image of at least a second item of the multiple items within the shopping cart is generated. The second image lacks an indication of the first item. The second image is displayed on the display system.

### BACKGROUND

Self-checkout systems include diverse functionality that enables users (e.g., customers) to perform some or all of the stages of a self-checkout transaction, such as scanning items, weighing items, bagging items, presenting payment, and providing a paper or electronic receipt. For example, a self-checkout system may include a shelf for holding a shopping basket, one or more scanners for scanning items a customer wishes to purchase, a bagging area for placing the items in bags after they have been scanned, and a point-of-sale (POS) device for processing the payment for the items scanned by the customer.

### BRIEF DESCRIPTION OF THE DRAWINGS

FIG. 1 illustrates an example self-checkout system, according to one embodiment.

FIG. 2 is a flowchart of a method for scanning verification for a self-checkout transaction, according to one embodiment.

FIGS. 3A-3E illustrate an example scenario for scanning verification for a self-checkout transaction, according to one embodiment.

FIG. 4 is a flowchart of another method for scanning verification for a self-checkout transaction, according to one embodiment.

### DETAILED DESCRIPTION

Self-checkout systems may include various functionality to facilitate the scanning of items by customers. For example, self-checkout systems may include different types of scanners, including handheld scanners, integrated scanners (e.g., scanners integrated into the self-checkout system, such as a flatbed scanner), and scanners with integrated load cell(s) for measuring weight of item(s), as illustrative, non-limiting examples.

In some cases, the customer may use a handheld scanner to scan items in the customer’s shopping cart (or basket) without physically removing the items from the customer’s shopping cart. For example, the customer’s shopping cart (or basket) may include multiple items, one or more heavy items, one or more obtuse (or irregular) items, or a combination thereof, making it infeasible and/or impractical for the customer to remove items from the shopping cart, scan the items using an integrated scanner (e.g., flatbed scanner) of the self-checkout system, and place the items into the bagging area of the self-checkout system. For example, a customer may be unable to remove a heavy item from the shopping cart without the aid of another user (e.g., customer or store personnel).

One potential issue with enabling a customer to scan items in a shopping cart with a handheld scanner (e.g., without removing the items) is that the customer may not be able to remember which items have been scanned and whether all items in the shopping cart have been scanned. This scenario can degrade customer experience, reduce the efficiency of the self-checkout transaction, and lead to retail shrinkage.

Embodiments herein describe techniques for using image processing and artificial intelligence (AI)/machine learning (ML) to scan and verify whether a customer has scanned all items in the customer’s shopping cart with a handheld scanner. For example, in some embodiments, a scanning verification system for a self-checkout system may use one or more camera devices to capture images (and/or video) of items within a customer’s shopping cart. The one or more camera devices may include camera devices from the handheld scanner, camera devices of the self-checkout system, camera devices of the environment in which the self-checkout system is located, or a combination thereof. The scanning verification system may cause an image of the items to display on a display system associated with the self-checkout system.

As each item from the shopping cart is scanned by the customer, the scanning verification system may edit the image being displayed on the display system of the self-checkout system (e.g., using one or more image processing techniques and/or AI/ML techniques) to remove the item that was scanned from the image. In this manner, the scanning verification system can provide an indication to the customer of whether the customer has scanned each item in their shopping cart with the handheld scanner. Once all items have been scanned, the scanning verification system may cause an indication that scanning is complete to display on the display system. If the customers attempts to complete the self-checkout transaction before scanning all items, the scanning verification system may cause an indication that one or more items are unscanned to display on the display system and prompt the customer to scan the unscanned item(s).

Advantageously, embodiments described herein can reduce retail shrinkage that occurs to due customers failing to scan all items within a shopping cart with a handheld scanner. As such, embodiments can significantly increase the efficiency of the self-checkout transaction in the retail store and enhance customer experience.

Note, the techniques described herein for AI/ML-based scanning verification for a self-checkout system may be incorporated into (such as implemented within or performed by) a variety of wired or wireless apparatuses. In some implementations, an apparatus may provide connectivity to or from a network (such as a wide area network (WAN) such as the Internet or a cellular network) via a wired or wireless communication link. In some implementations, an apparatus may include a self-checkout system or a computing system located in a cloud computing environment.

While features of the self-checkout system are generally discussed within the context of a shopping environment, such as within a retail store, it is contemplated that the techniques disclosed herein may be applied to other environments, such as libraries, museums, classrooms, and hospitals, as illustrative, non-limiting examples.

### Advantages of AI-based Scanning Verification for a Self-Checkout Transaction

A self-checkout system may include multiple different scanners to provide a customer with flexibility in scanning items as part of the self-checkout transaction. For example, many self-checkout systems may include a handheld scanner that allows the customer to scan items in the customer’s shopping cart without removing the items from the shopping cart. The embodiments herein provide automatic methods, e.g., without human intervention, for automatically detecting, using image processing, whether a customer has scanned all items in their shopping cart with a handheld scanner. Embodiments herein can also provide a visual indication to the user of whether each item has been scanned, e.g., by automatically editing an image displayed on a display system of the self-checkout system to remove each item that is scanned by the customer from the image. Doing so can reduce the amount of retail shrinkage that occurs due to use of handheld scanners to complete self-checkout transactions.

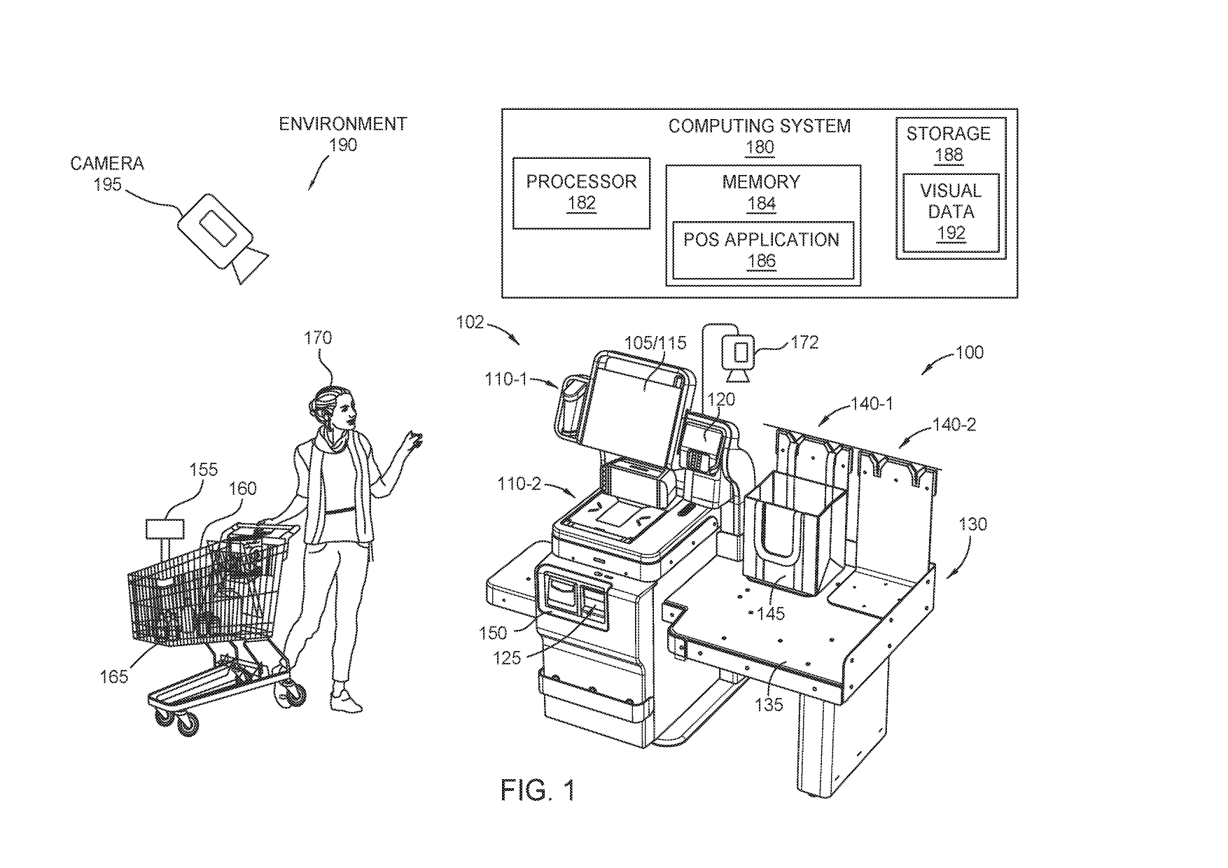

FIG. 1 illustrates an example implementation of a self-checkout system 100, according to one embodiment. The self-checkout system 100 generally includes functionality that enables a customer and/or an associate to perform some or all of the stages of a self-checkout transaction, such as scanning items, weighing items, bagging items, presenting payment, and providing a paper or electronic receipt. The self-checkout system 100 may be located within an environment 190, such as a retail environment (e.g., grocery store, clothing store, electronics store, etc.).

The self-checkout system 100 includes a point-of-sale (POS) terminal 102 having a display system 105 that presents information viewable by a user 170 (e.g., a customer or an associate) during various stages of a self-checkout transaction. The display system 105 may use any suitable display technology, such as a liquid crystal display (LCD) or an organic light-emitting diode (OLED) display, as illustrative, non-limiting examples. The display system 105 is communicatively coupled with one or more computer processors, which may be integrated into the POS terminal 102 or external to the POS terminal 102. For example, the one or more computer processors may be included in a computing device integrated with the POS terminal 102, which may be further networked with other computing devices. In some embodiments, the display system 105 includes an input device 115 that receives inputs from the user 170 during the self-checkout transaction. For example, the input device 115 may include a touch-sensitive screen using any suitable sensing technology, such as capacitive sensing or resistive sensing, as illustrative, non-limiting examples.

The POS terminal 102 further includes one or more item scanners 110-1, 110-2 (collectively or generically, item scanner(s) 110). Each item scanner 110 is communicatively coupled with the one or more computer processors, and in conjunction with the one or more computer processors visually identifies items during scanning. For example, each item scanner 110 may detect encoded portions (e.g., a Universal Product Code (UPC) or a Quick Response (QR) code) on the item and/or may compare imagery of the item with reference image(s) to identify a type of the item.

In some embodiments, the item scanner 110-1 includes a handheld scanner that may be aimed by a user at items to scan the items, and the item scanner 110-2 is integrated into a surface of the POS terminal 102. In some embodiments, the item scanner 110-2 further includes one or more load cells arranged near the surface for measuring weights of items.

The self-checkout system 100 further includes a printer 125 that prints or otherwise generates tangible item(s) for the self-checkout transaction. As shown, the printer 125 is arranged in a forward panel 150 of the self-checkout system 100 beneath the item scanner 110-2, although the printer 125 may be arranged in any other suitable location. The printer 125 is communicatively coupled with the one or more computer processors. In some embodiments, the printer 125 generates paper receipts for the self-checkout transaction and/or coupons.

The self-checkout system 100 further includes a payment terminal 120 that is able to receive electronic payments from the user 170. In some embodiments, the payment terminal 120 includes one or more of: a credit card reader, a display device, a PIN pad, a near field communication (NFC) reader, and so forth. In some embodiments, the payment terminal 120 includes one or more computer processors, a memory, etc. that is distinct from the computing hardware of the POS terminal 102. In this way, the payment terminal 120 may be effectively isolated from the POS terminal 102 to ensure compliance with Payment Card Industry Data Security Standard (PCI DSS) or other standards.

The self-checkout system 100 may further include a cash receiver in the forward panel 150 that is configured to receive banknotes and/or coins from the user 170 as payment for the self-checkout transaction. In some cases, the cash receiver may be configured to dispense banknotes and/or coins to the user 170 as change.

The self-checkout system 100 further includes a bagging area 130 including multiple bagging stations 140-1, 140-2 (collectively or generically, bagging station(s) 140). Each bagging station 140 includes structure suitable for dispensing, supporting, suspending, and/or retaining single-use shopping bags and/or reusable bags or totes. As shown, the bagging stations 140-1, 140-2 are disposed on a fixed platform 135, and the bagging station 140-1 is engaged with a handle of a reusable tote 145 to retain the reusable tote 145 on the fixed platform 135. Other configurations of the bagging area 130 are also contemplated, such as different numbers and/or arrangements of the bagging stations 140, a rotatable carousel, and so forth.

In some cases, the user 170 may transport a shopping cart 160 (including one or more items 165) to the POS terminal 102 to initiate a self-checkout transaction. The user 170 may scan the item(s) 165 using the item scanner 110-2 (e.g., integrated flatbed scanner) and place the scanned item(s) into the bagging area 130, e.g., into the reusable tote 145 or onto the fixed platform 135. In some cases, the user 170 may scan the item(s) 165 using the item scanner 110-1 (e.g., handheld scanner) without removing the item(s) 165 from the shopping cart 160. For example, the shopping cart 160 may include one or more heavy items and/or obtuse (or irregular) items that make it impractical or infeasible for the user 170 to remove the item(s) from the shopping cart during the self-checkout transaction. In such cases, the item scanner 110-1 provides a convenient option for the user to scan the item(s) without removing the items from the shopping cart. After scanning item(s) 165 with the item scanner 110-1, the user 170 may keep the scanned item(s) within the shopping cart 160, as opposed to placing the scanned item(s) into the bagging area 130.

During the self-checkout transaction, the POS terminal 102 may update a list of items included in the self-checkout transaction as the user 170 adds or removes items from the bagging area 130 or shopping cart 160. The POS terminal 102 may also provide guidance (e.g., instructions) to the user 170 via the display system 105. The user 170 may request assistance via inputs to the POS terminal 102 (e.g., touch inputs to the input device 115).

The self-checkout transaction may be monitored by one or more cameras disposed in the environment 190. For example, in some embodiments, an overhead camera 172 is mounted at the top of an enclosure of the self-checkout system 100 so its field-of-view (FOV) includes the self-checkout system 100 (including the shopping cart 160). That way, the camera 172 can capture images (as well as video) of the user 170 moving items onto and over the item scanner 110-2 and/or the user 170 using item scanner 110-2 to scan items 165 within the shopping cart 160. In some embodiments, the item scanners 110 may include integrated cameras. For example, the item scanner 110-1 (e.g. handheld scanner) and/or the item scanner 110-2 (e.g., flatbed scanner) may include an integrated camera that captures images (and/or video) of items being scanned.

In some embodiments, the environment 190 includes one or more cameras 195 located external to the self-checkout system 100. The camera(s) 195 may be part of a surveillance system of the environment 190. The camera(s) 195 may be communicatively coupled to the self-checkout system 100 and/or to a computing system that is communicatively coupled to the self-checkout system. In some embodiments, the shopping cart 160 may be equipped with one or more cameras 155. The camera(s) 155 may be configured to capture images of items (or other contents) within the shopping cart 160. The camera(s) 155 may be installed or disposed in different locations of the shopping cart 160, such as the sides of the shopping cart 160, bottom of the shopping cart 160, front of the shopping cart, and so forth. The camera(s) 155 may be communicatively coupled to the self-checkout system 100 and/or to a computing system that is communicatively coupled to the self-checkout system.

In some embodiments, the images (and/or video) captured from the camera(s) 195, camera(s) 155, camera(s) 172 and/or integrated camera(s) of the item scanners 110 may be transmitted to the self-checkout system 100 and/or another computing system for processing and analysis, such as identifying the type of items within the shopping cart and generating an image of the items for displaying on the display system 105. In some cases, the visual data (e.g., images and/or video) captured from multiple cameras may be aggregated and registered in order to generate the image of the items that is displayed on the display system. In some embodiments, the collected visual data, processed visual data, or a combination thereof, may be stored in a storage system (e.g., storage 188) communicatively coupled to the self-checkout system 100.

The self-checkout system 100 also includes a computing system 180. The computing system 180 may be integrated into an enclosure (e.g., as part of the POS terminal 102) of the self-checkout system 100 or may be located external to the self-checkout system 100 but communicatively coupled to the self-checkout system 100 using, e.g., an Ethernet cable or wireless connection. The computing system 180 can represent any number of computing devices. For example, the computing system 180 can be implemented by a computer device disposed in the POS terminal 102, can be a server that is disposed elsewhere in the environment 190, can be one or more computer devices located in a cloud computing environment, or a combination thereof.

The computing system 180 includes a processor 182, memory 184, and storage 188. The processor 182 represents one or more processing elements which each can include one or more processing cores. The memory 184 can be volatile memory, non-volatile memory, and combinations thereof. The memory 184 includes various instructions that are executable by the processor 182 to perform one or more techniques described herein, e.g., for verifying that a customer has scanned all items within a shopping cart with a handheld scanner. Here, the memory 184 includes a POS application 186 (e.g., a software application) that controls the operations of the self-checkout system 100. For example, the POS application 186 can include any number of software modules (or a suite of software applications) that communicates with the POS terminal 102 (including item scanners 110, display system 105, input device 115), payment terminal 120, camera(s) 172, camera(s) 195, camera(s) 155, other components in the self-checkout system 100, other computing systems in the environment 190, or a combination thereof. The POS application 186 can receive input from these components as well as send instructions. For example, the POS application 186 may cause certain visual components (e.g., graphical features, graphical structures, and/or graphical elements that compose a virtual reality (VR), mixed reality (MR), and/or artificial intelligence (AI) generated image) generated using the techniques described herein to display on the display system 105.

In some embodiments, the POS application 186 performs AI-based scanning verification as part of a self-checkout transaction. For example, the POS application 186 can process visual data of items 165 within the shopping cart 160 captured from one or more cameras (e.g., camera(s) 155, camera(s) 195, camera(s) 172, and/or integrated cameras in item scanners 110) in the environment 190, generate (e.g., using image processing techniques) an image of the items, and cause the image to display on the display system 105 for viewing by the user 170 during the self-checkout transaction. As the user 170 scans each item 165 in the shopping cart 160 with the item scanner 110-1 (e.g., handheld scanner), the POS application 186 may edit the image to remove the item that was scanned from the image. In this manner, the POS application 186 may provide an indication to the user 170 of which item(s) have been scanned and which item(s) have not been scanned.

The indication may be one or more graphical patterns, one or more graphical structures, and/or one or more graphical elements that form (or compose) a virtual reality (VR), mixed reality (MR), and/or artificial intelligence (AI) generated image, among other visual components. In an illustrative, non-limiting example, the indication may include graphical user interface (GUI) components that can be displayed on the display system 105. The GUI components may include, for example, hypertext markup language (HTML) components or code that generates HTML components that can be passed to the display system 105 and rendered as a graphical pattern(s)/structure(s)/element(s) on the display system 105. The GUI components may additionally include instructions executable by the processor 182 to display the graphical pattern(s)/structure(s)/element(s) using language-specific or operating system-specific GUI components (e.g., Abstract Window Toolkit, Swing API components on the Java platform, and so on). Generally, instructions capable of rendering a GUI on the display system 105 may include computer executable code generated from compiling and/or interpreting C (or variants thereof), Java, PHP, Ruby, HTML, javascript, Python, AJAX, VBscript, and other programming or scripting languages used to compose and present a GUI.

Once all items have been scanned, the POS application 186 may cause an indication that scanning is complete to display on the display system 105. In some embodiments, such an indication may be in the form of an image of an empty shopping cart. As noted, however, in general, such an indication may include any graphical pattern(s), graphical structure(s), and/or graphical element(s) that compose a VR, MR, and/or AI generated image, among other visual components. In some embodiments, if the user 170 attempts to complete the self-checkout transaction before scanning all items within the shopping cart 160, the POS application 186 may cause an indication that one or more items 165 are unscanned to display on the display system 105 and cause a prompt requesting the user 170 to scan the unscanned items 165 to display on the display system 105.

Note that FIG. 1 illustrates a reference example configuration of a self-checkout system 100 in which the techniques presented herein can be implemented and that other configurations of the self-checkout system consistent with the functionality described herein are contemplated.

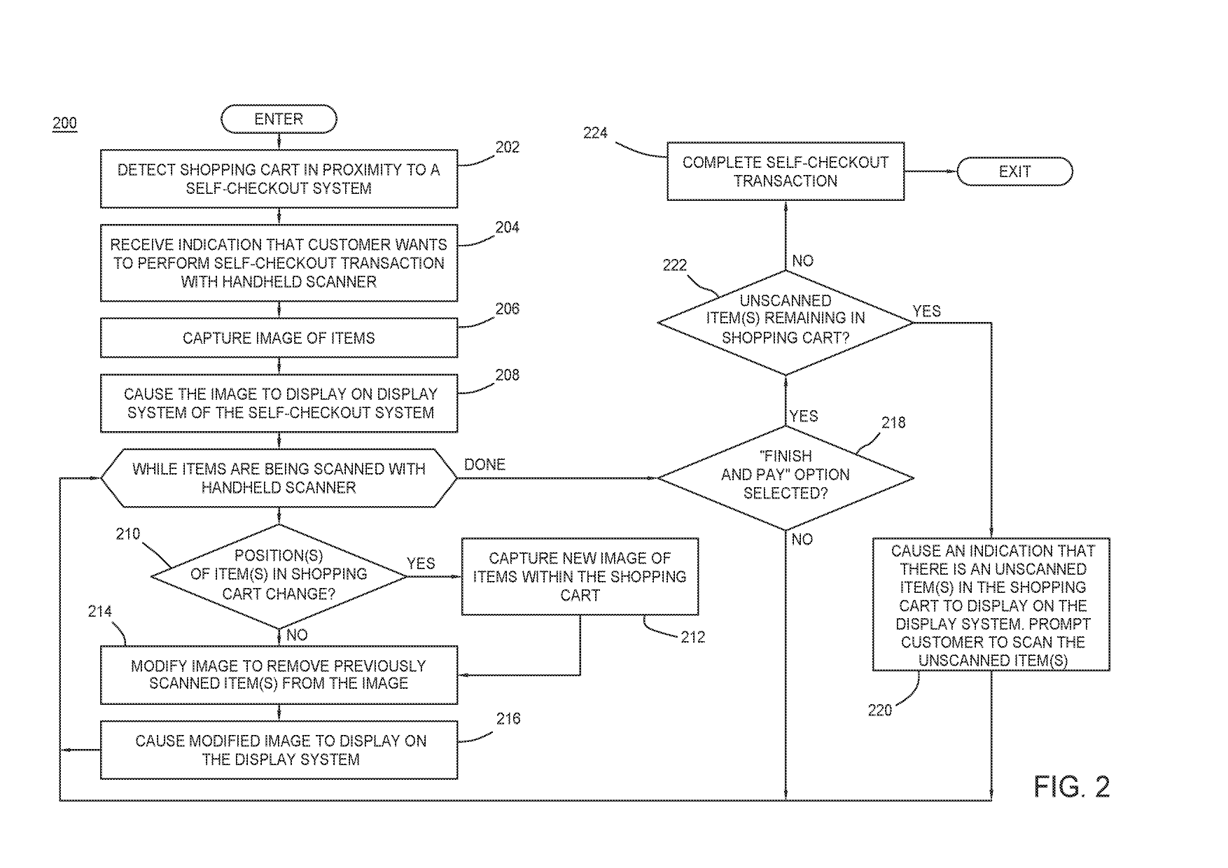

FIG. 2 is a flowchart of a method 200 for performing scanning verification of a self-checkout transaction, according to one embodiment. Method 200 may be performed by a computing system (e.g., computing system 180). In some cases, method 200 may be performed while a customer is in the process of using the self-checkout system (e.g., self-checkout system 100) for the self-checkout transaction.

Method 200 may enter at block 202 where the computing system detects a shopping cart in proximity to the self-checkout system. For example, the computing system may detect the shopping cart using one or more proximity sensors, camera devices (e.g., camera device 172), or a combination thereof.

At block 204, the computing system receives an indication that the customer wants to perform a self-checkout transaction with a handheld scanner. For example, the customer may use the POS terminal 102 to indicate that the customer wants to perform the self-checkout transaction with the handheld scanner.

At block 206, the computing system captures an image of item(s) within the shopping cart, e.g., via one or more camera devices, such as camera device 172, integrated camera within item scanner 110-1, camera device 195, camera device 155, or a combination thereof.

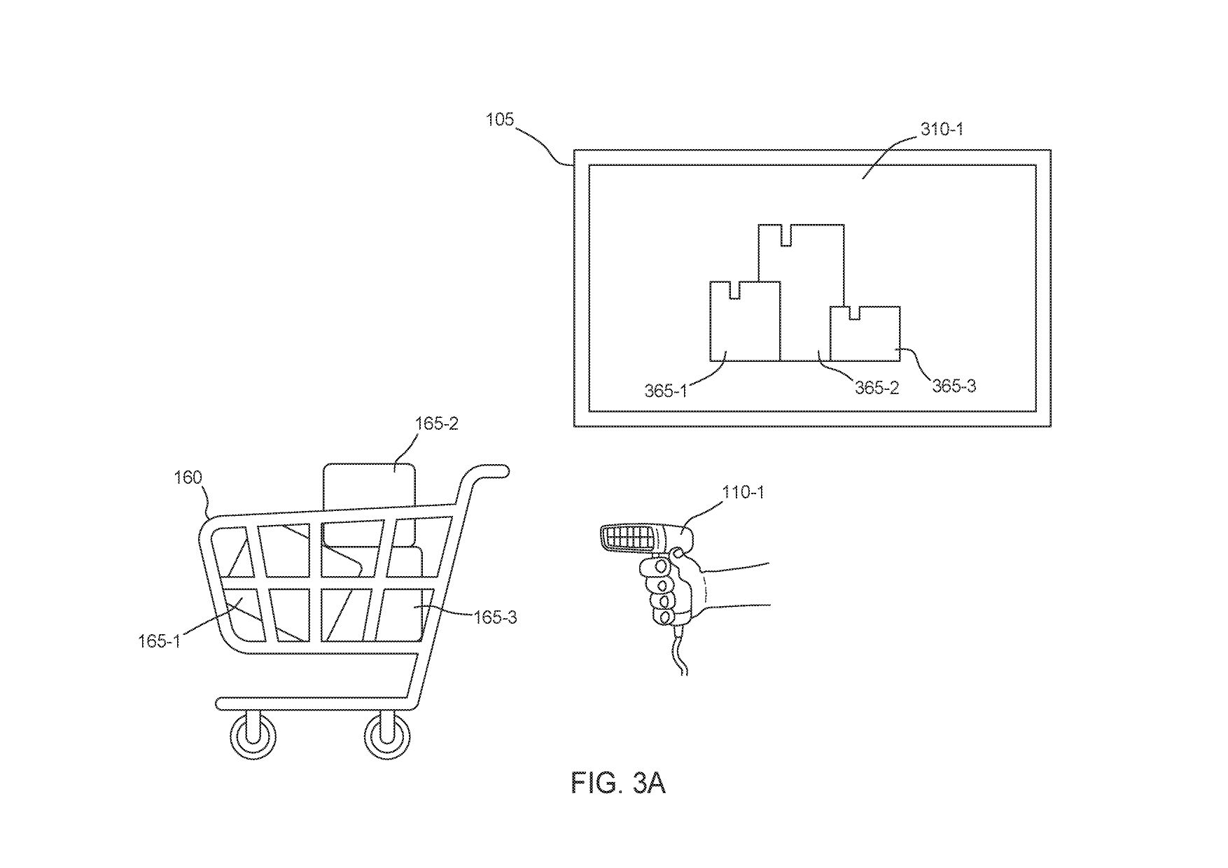

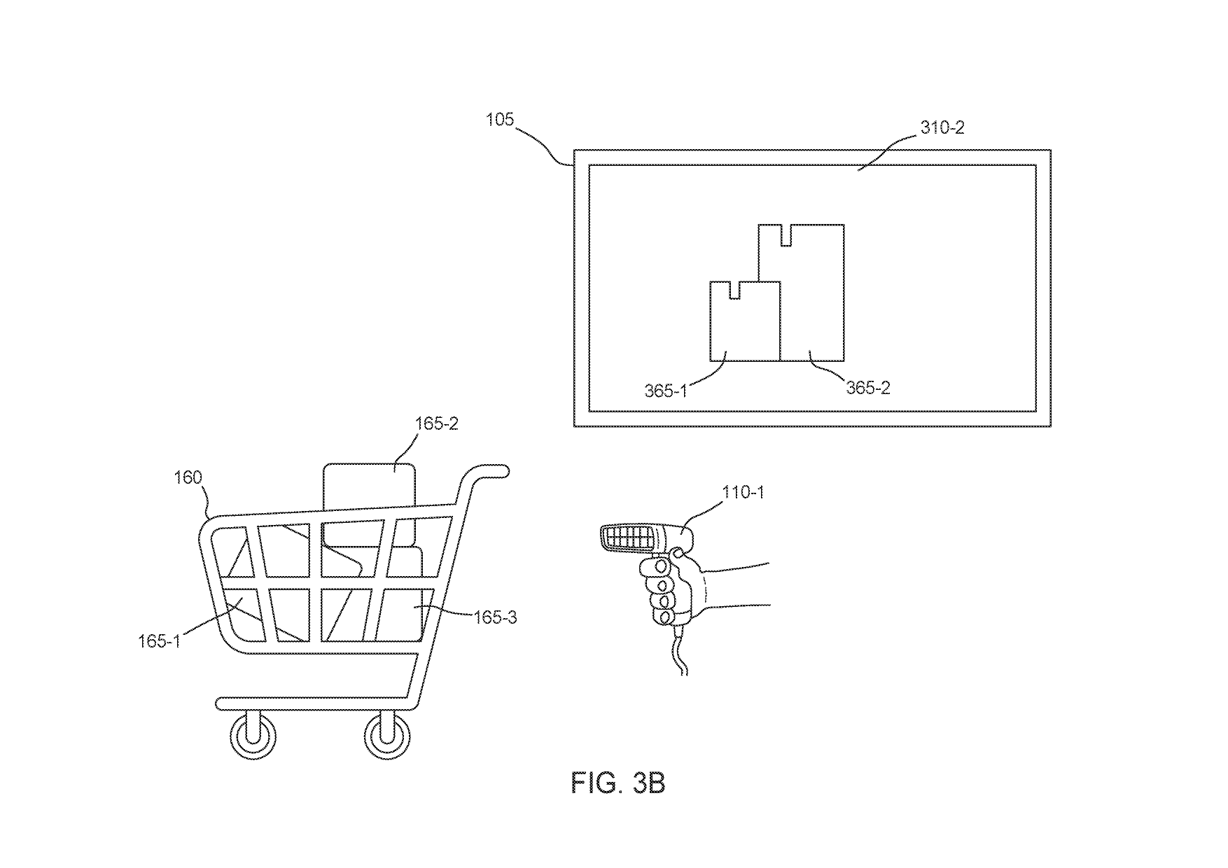

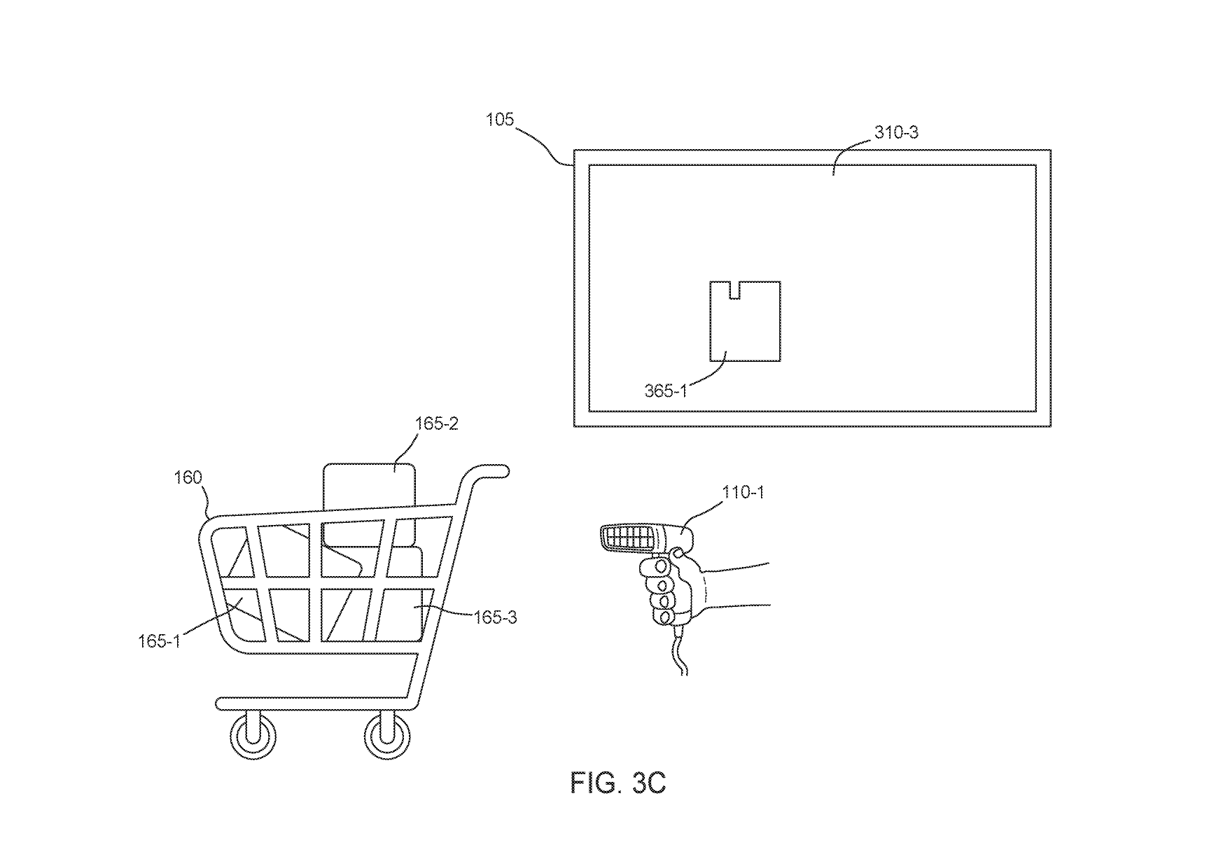

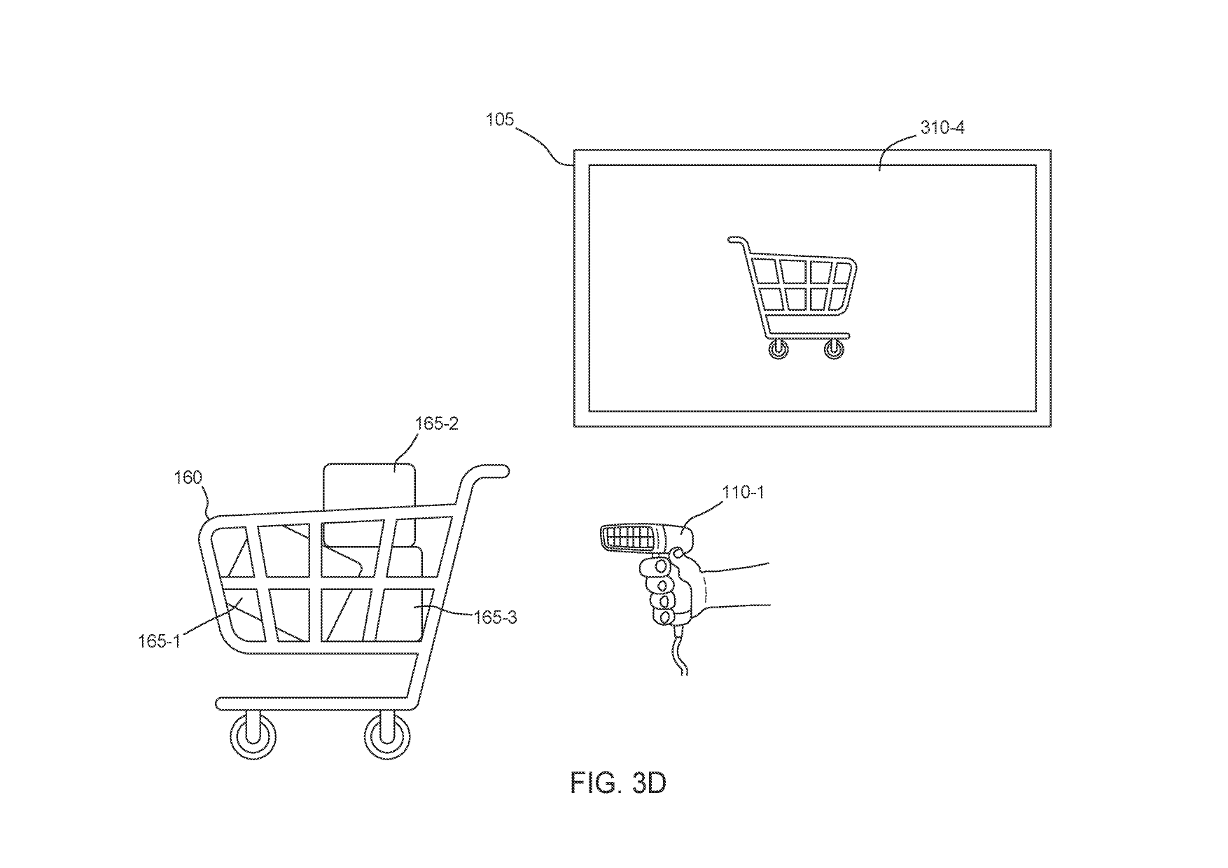

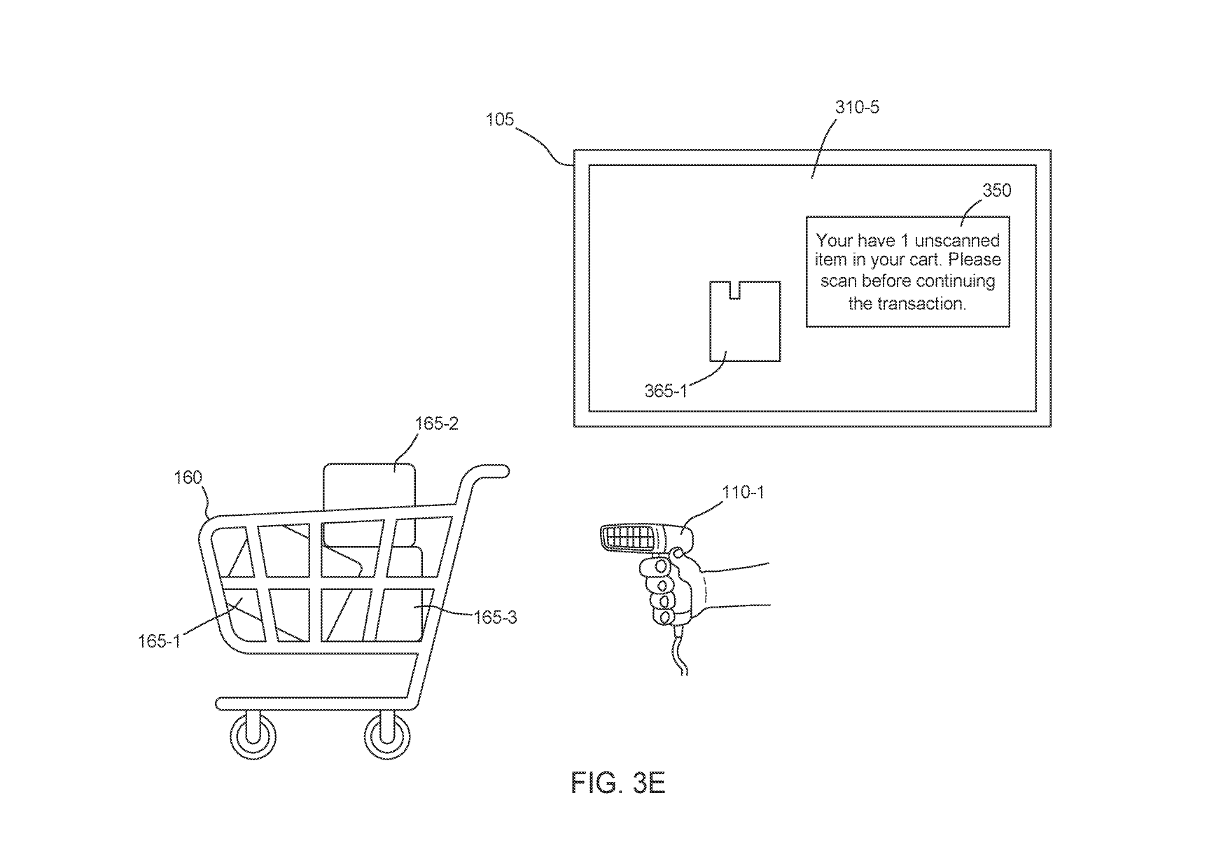

At block 208, the computing system causes the image to display on a display system (e.g., display system 105) of the self-checkout system. Using the reference example depicted in FIG. 3A, the computing system may capture an image(s) of the items 165 1-3 within shopping cart 160 and generate an image 310-1 based on the captured image(s). In some cases, the generated image 310-1 may be the same as the captured image (e.g., the computing system may capture a single image of the items 165 1-3). In other cases, the generated image 310-1 may be a registered image from multiple images captured from one or more camera devices. As shown in FIG. 3A, the computing system may cause the generated image 310-1 to display on the display system 105. The generated image 310-1 includes an indication 365-1 of the item 165-1 within the shopping cart 160, an indication 365-2 of the item 165-2 within the shopping cart 160, and an indication 365-3 of the item 165-3 within the shopping cart 160. The indications 365-1 to 365-3 may be in the form of a graphical pattern(s), graphical structure(s), and/or one or more graphical elements that make up a VR, MR, and/or AI generated image, among other visual components.

Referring back to FIG. 2, one or more of blocks 210, 212, 214, and 216 may be performed while items are being scanned with the handheld scanner. At block 210, the computing system determines whether a position of at least one of the items within the shopping cart has changed. In certain embodiments, the computing system may determine whether the position of at least one of the items within the shopping cart has changed based on performing a difference operation (e.g. image diff) between one or more images captured by the one or more camera devices. In such embodiments, the computing system may continually capture images of the self-checkout area that includes the self-checkout system and the shopping cart.

If the computing system determines that the position of at least one item in the shopping cart has changed, then the method 200 proceeds to block 212. If there has not been a change in the position(s) of the item(s), then the method 200 proceeds to block 214.

At block 212, the computing system captures a new image of the items within the shopping cart, e.g., using one or more camera devices, such as camera device 172, integrated camera within item scanner 110-1, camera device 195, camera device 155, or a combination thereof.

At block 214, the computing system modifies the image to remove previously scanned item(s) from the image. At block 216, the computing system causes the modified image to display on the display system. For instance, referring to FIG. 3B, the computing system may modify the image 310-1 to remove the indication 365-3 of the third item 165-3 from the image 310-1, and cause the modified image 310-2 to display on the display system 105.

Referring back to FIG. 2, the computing system may continue performing one or more of blocks 210, 212, 214, and 216 while items are being scanned with the handheld scanner. For example, referring to FIG. 3C, after the user scans item 165-2 with the handheld scanner (e.g., item scanner 110-1), the computing system may modify the image 310-2 to remove the indication 365-2 of the item 165-2 from the image 310-2, and may cause the modified image 310-3 to display on the display system 105. Additionally, referring to FIG. 3D, after the user scans item 165-1 with the handheld scanner, the computing system may modify the image 310-3 to remove the indication 365-1 of the item 165-1 from the image 310-3, and may cause the modified image 310-4 to display on the display system 105. Note while the depicted example in FIG. 3D shows the computing system causing an image of an empty shopping cart to display on the display system, the computing system may cause any indication to indicate that all items 165 within the shopping cart 160 have been scanned to display on the display system.

Referring back to FIG. 2, at block 218, the computing system determines whether the user has selected “finish and pay” option on the display system 105 (or otherwise indicated that the user has finished scanning items with the handheld scanner). If so, then the method 200 proceeds to block 222. At block 222, the computing system determines if there are any unscanned items remaining in the shopping cart. If so, then the method 200 proceeds to block 220. If not, then the method 200 proceeds to block 224.

At block 220, the computing system causes an indication that there is at least one unscanned item in the shopping cart to display on the display system and causes a prompt to display on the display system requesting the user to scan the unscanned item(s). For example, referring to FIG. 3E, assuming the user attempts to complete the self-checkout transaction without scanning item 165-1, the computing system may cause an image 310-5 including the prompt 350 along with the indication 365-1 of the unscanned item 165-1 to display on the display system 105.

Referring back to FIG. 2, at block 224, the computing system may complete the self-checkout transaction, e.g., by prompting the user for payment, etc. The method 200 may then exit.

Note, the computing system may use a variety of AI/ML techniques and/or image processing techniques to modify images that are displayed on the display system. For example, in some cases, the computing system may employ an AI image generator to generate/modify images for scanning verification. AI image generators are generally based on deep learning neural networks that are trained on a large dataset of images. The AI image generator can be used to generate a new image by predicting pixel values, based on patters learned from the training data. Examples of AI image generators may include, but are not limited to, style transfer, generative adversarial network (GAN), variational autoencoder, deep dream, neural style transfer, and stable diffusion, among others.

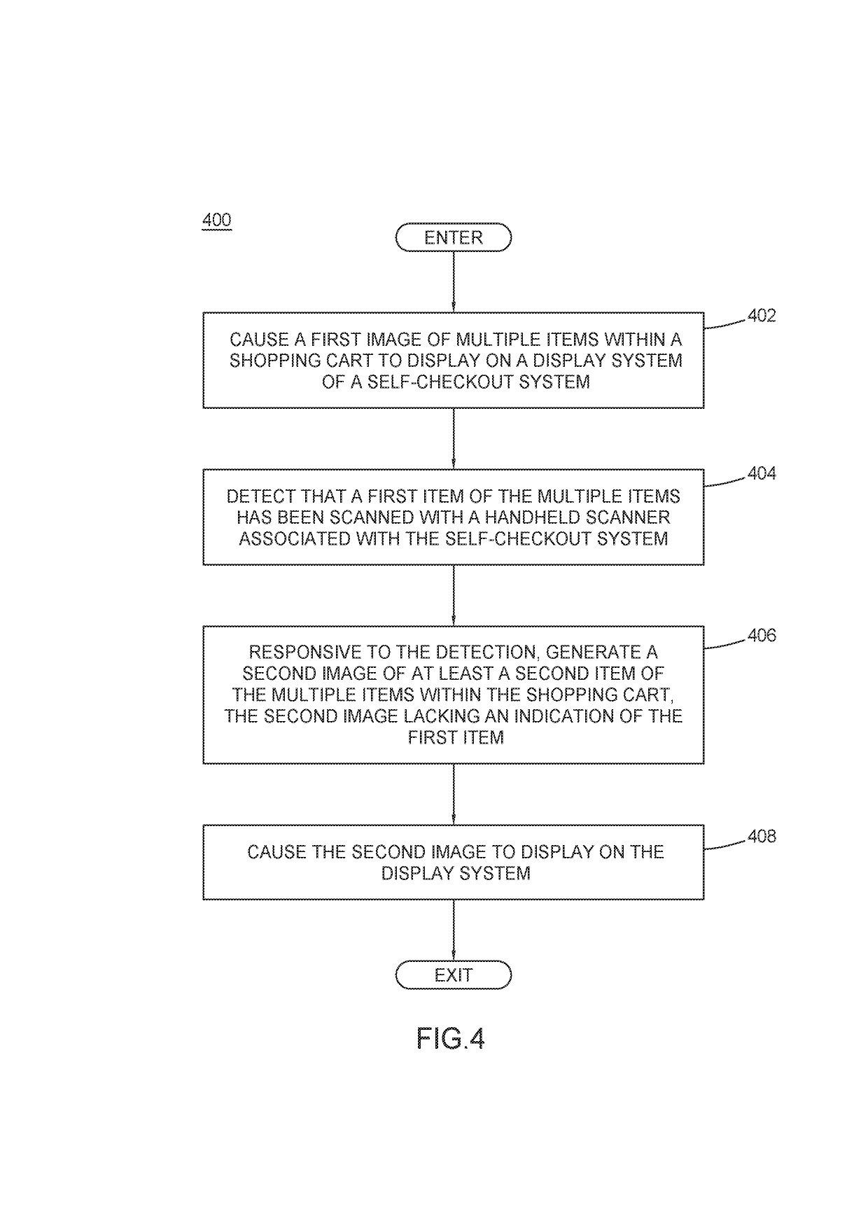

FIG. 4 is a flowchart of another method 400 for performing scanning verification of a self-checkout transaction, according to one embodiment. Method 400 may be performed by a computing system (e.g., computing system 180). In some cases, method 400 may be performed while a customer is in the process of using a self-checkout system (e.g., self-checkout system 100) for a self-checkout transaction.

Method 400 may enter at block 402, where the computing system causes a first image (e.g., image 310-1) of multiple items (e.g., items 165 1-3) within a shopping cart to display on a display system (e.g., display system 105) of the self-checkout system. The first image may include a respective indication (e.g., indication(s) 365) of each item within the shopping cart.

At block 404, the computing system detects that a first item (e.g., item 165-3) of the multiple items has been scanned with a handheld scanner (e.g., item scanner 110-1) associated with the self-checkout system.

At block 406, the computing system, responsive to the detection, generates a second image (e.g., image 310-2) of at least a second item of the multiple items within the shopping cart. The second image lacks an indication (e.g., indication 365-3) of the first item.

At block 408, the computing system causes the second image to display on the display system.

In certain embodiments, generating the second image (at block 406) may include (i) modifying the first image to remove the first item from the first image and (ii) using the modified first image as the second image.

In certain embodiments, the method 400 may further involve the computing system, upon detecting a change in at least one of a position or orientation of at least one item of the plurality of items, obtaining a third image of the multiple items within the shopping cart. In such embodiments, generating the second image (at block 406) may include (i) modifying the third image to remove the first item from the third image, and (ii) using the modified third image as the second image. The method 400 may further involve the computing system modifying the third image to remove, from the third image, a third item of the multiple items that has been scanned with the handheld scanner, the second image further lacking an indication of the third item.

In certain embodiments, the method 400 may further involve the computing system (i) receiving a request to complete a self-checkout transaction with the multiple items, (ii) after receiving the request, determining that at least one of the multiple items has not been scanned with the handheld scanner, and (iii) responsive to the determination, causing an indication of the at least one of the multiple items that has not been scanned to display on the display system. In such embodiments, the method 400 may further involve the computing system, responsive to the determination, causing a prompt requesting a user of the self-checkout system to scan the at least one of the plurality of items that has not been scanned to display on the display system. In some cases, the at least one of the multiple items that has not been scanned may include at least the second item of the multiple items, and the indication of the at least one of the multiple items that has not been scanned may include the second image.

In certain embodiments, the method 400 may further involve the computing system system (i) receiving a request to complete a self-checkout transaction with the multiple items, (ii) after receiving the request, determining that each of the multiple items has been scanned with the handheld scanner, and (iii) responsive to the determination, causing a third image indicating that each of the multiple items has been scanned to display on the display system. In such embodiments, the third image may lack any indication of the multiple items.

In certain embodiments, the method 400 may further involve the computing system (i) obtaining one or more third images of the plurality of items within the shopping cart, and (ii) generating the first image from the one or more third images. The one or more third images may be obtained from at least one of: (i) a first camera device integrated within the handheld scanner, (ii) a second camera device mounted to the self-checkout system, (iii) a third camera device deployed in an environment in which the self-checkout system is located, or (iv) a fourth camera device deployed in the shopping cart, each of the first camera device, the second camera device, the third camera device, and the fourth camera device having a field-of-view of at least one of the plurality of items and being communicatively coupled to the self-checkout system.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to the described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s). Additionally, when elements of the embodiments are described in the form of “at least one of A and B,” or “at least one of A or B,” it will be understood that embodiments including element A exclusively, including element B exclusively, and including element A and B are each contemplated.

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the described embodiments, a user may access applications (e.g., POS application 186, AI/ML model(s), visual data 192) and/or related data (e.g., captured images and/or video) available in the cloud. Doing so allows a user to access this information from any computing system attached to a network connected to the cloud (e.g., the Internet).

While the foregoing is directed to one or more embodiments, other and further embodiments may be devised without departing from the basic scope thereof, and the scope thereof is determined by the claims that follow.

What is claimed is:

1. A computer-implemented method comprising:
causing a first image of a plurality of items within a shopping cart to display on a display system of a self-checkout system;
detecting that a first item of the plurality of items has been scanned by a handheld scanner of the self-checkout system;
responsive to the detection, generating a second image of at least a second item of the plurality of items within the shopping cart, the second image lacking an indication of the first item; and
causing the second image to display on the display system.

2. The computer-implemented method of claim 1, wherein generating the second image comprises:
modifying the first image to remove the first item from the first image; and
using the modified first image as the second image.

3. The computer-implemented method of claim 1, further comprising:
upon detecting a change in at least one of a position or orientation of at least one item of the plurality of items, obtaining a third image of the plurality of items within the shopping cart, wherein generating the second image comprises:
modifying the third image to remove the first item from the third image; and
using the modified third image as the second image.

4. The computer-implemented method of claim 3, further comprising modifying the third image to remove, from the third image, a third item of the plurality of items that has been scanned with the handheld scanner, the second image further lacking an indication of the third item.

5. The computer-implemented method of claim 1, further comprising:
receiving a request to complete a self-checkout transaction with the plurality of items;
after receiving the request, determining that at least one of the plurality of items has not been scanned with the handheld scanner; and
responsive to the determination, causing an indication of the at least one of the plurality of items that has not been scanned to display on the display system.

6. The computer-implemented method of claim 5, further comprising responsive to the determination, causing a prompt to display on the display system, the prompt requesting a user of the self-checkout system to scan the at least one of the plurality of items that has not been scanned.

7. The computer-implemented method of claim 5, wherein:
the at least one of the plurality of items that has not been scanned comprises at least the second item of the plurality of items; and
the indication of the at least one of the plurality of items that has not been scanned comprises the second image.

8. The computer-implemented method of claim 1, further comprising:
receiving a request to complete a self-checkout transaction with the plurality of items;
after receiving the request, determining that each of the plurality of items has been scanned with the handheld scanner; and
responsive to the determination, causing a third image to display on the display system, the third image indicating that each of the plurality of items has been scanned.

9. The computer-implemented method of claim 8, wherein the third image lacks any indication of the plurality of items.

10. The computer-implemented method of claim 1, further comprising:
obtaining one or more third images of the plurality of items within the shopping cart; and
generating the first image from the one or more third images.

11. The computer-implemented method of claim 10, wherein the one or more third images are obtained from at least one of: (i) a first camera device integrated within the handheld scanner, (ii) a second camera device mounted to the self-checkout system, (iii) a third camera device deployed in an environment in which the self-checkout system is located, or (iv) a fourth camera device deployed in the shopping cart, each of the first camera device, the second camera device, the third camera device, and the fourth camera device having a field-of-view of at least one of the plurality of items and being communicatively coupled to the self-checkout system.

12. A self-checkout system, comprising:
a handheld scanner;
a display system; and
a computing system for controlling the self-checkout system, the computing system configured to:
cause a first image of a plurality of items within a shopping cart to display on the display system;
detect that a first item of the plurality of items has been scanned by the handheld scanner;
responsive to the detection, generate a second image of at least a second item of the plurality of items within the shopping cart, the second image lacking an indication of the first item; and
cause the second image to display on the display system.

13. The self-checkout system of claim 12, wherein to generate the second image, the computing system is configured to:
modify the first image to remove the first item from the first image; and
use the modified first image as the second image.

14. The self-checkout system of claim 12, wherein:
the computing system is further configured to upon detecting a change in at least one of a position or orientation of at least one item of the plurality of items, obtain a third image of the plurality of items within the shopping cart; and
to generate the second image, the computing system is configured to:
modify the third image to remove the first item from the third image; and
use the modified third image as the second image.

15. The self-checkout system of claim 14, wherein the computing system is further configured to modify the third image to remove, from the third image, a third item of the plurality of items that has been scanned with the handheld scanner, the second image further lacking an indication of the third item.

16. The self-checkout system of claim 12, wherein the computing system is further configured to:
receive a request to complete a self-checkout transaction with the plurality of items;
after receiving the request, determine that at least one of the plurality of items has not been scanned with the handheld scanner; and
responsive to the determination, cause an indication of the at least one of the plurality of items that has not been scanned to display on the display system.

17. The self-checkout system of claim 16, wherein the computing system is further configured to, responsive to the determination, cause a prompt to display on the display system, the prompt requesting a user of the self-checkout system to scan the at least one of the plurality of items that has not been scanned.

18. The self-checkout system of claim 16, wherein:
the at least one of the plurality of items that has not been scanned comprises at least the second item of the plurality of items; and
the indication of the at least one of the plurality of items that has not been scanned comprises the second image.

19. The self-checkout system of claim 12, wherein the computing system is further configured to:
receive a request to complete a self-checkout transaction with the plurality of items;
after receiving the request, determine that each of the plurality of items has been scanned with the handheld scanner; and
responsive to the determination, cause a third image indicating that each of the plurality of items has been scanned to display on the display system.

20. A non-transitory computer-readable medium comprising computer-executable instructions, which when collectively executed by one or more processors of a computing system cause the computing system to perform an operation comprising:
causing a first image of a plurality of items within a shopping cart to display on a display system of a self-checkout system;
detecting that a first item of the plurality of items has been scanned by a handheld scanner associated with the self-checkout system;
responsive to the detection, generating a second image of at least a second item of the plurality of items within the shopping cart, the second image lacking an indication of the first item; and
causing the second image to display on the display system.
